(19) United States
(12) Patent Application Publication
(10) Pub. No.: US 2018/0241757 A1
(43) Pub. Date: Aug. 23, 2018

(54) SECURITY PROCEDURES FOR THE CELLULAR INTERNET OF THINGS

(71) Applicant: NOKIA SOLUTIONS AND NETWORKS OY, Espoo (FI)

(72) Inventor: Guenther HORN, Munich (DE)

(21) Appl. No.: 15/748,812

(22) PCT Filed: Aug. 16, 2016
(86) PCT No.: PCT/EP2016/069409

§ 371 Date: Jan. 30, 2018

Related U.S. Application Data
(60) Provisional application No. 62/205,774, filed on Aug. 17, 2015.

(51) Int. Cl. H04L 29/06; H04W 12/04; H04W 12/06; H04W 8/20

(52) U.S. Cl. CPC H04L 63/105; H04L 63/20; H04L 63/102; H04W 12/06; H04W 8/20; H04W 12/04

(57) ABSTRACT

Various communication systems may benefit from appropriate security measures. For example, the cellular internet of things may benefit from suitable security procedures. A method can include including a first field in a subscriber profile. The first field can be configured to determine a minimum strength for at least one cryptographic algorithm to be used between a user equipment associated with this subscription and a support node. The method can also include transmitting the subscriber profile between a subscriber database and the support node.

### CROSS-REFERENCE TO RELATED APPLICATION

This application is related to and claims the benefit and priority of U.S. Provisional Patent Application No. 62/205,774, filed Aug. 17, 2015, which is hereby incorporated herein by reference.

### BACKGROUND

### Field

Various communication systems may benefit from appropriate security measures. For example, the cellular internet of things may benefit from suitable security procedures.

### Description of the Related Art

The Cellular Internet of Things (CIoT) is an area of the third generation partnership project (3GPP) and is related to various 3GPP working groups, in particular global system for mobile communication (GSM) enhanced data rates for GSM evolution (EDGE) radio access network (GERAN), RAN2, SA2, and SA3, including security.

The 3GPP work on security for the CIoT is split into two streams: one that relates to improving on general packet radio service (GPRS) security, and another that relates to providing end-to-middle (e2m) security for CIoT between the device and a CIoT server in the home network. The CIoT server in the home network can be referred to as a home public land mobile network (HPLMN) security endpoint (HSE).

The current state of the discussion for e2m security for CIoT is captured in a draft technical report (TR), namely 3GPP TR 33.863 v0.2.0 “Study on battery efficient security for very low throughput Machine Type Communication Devices; (Release 13),” available at http://www.3gpp.org/DynaReport/33863.htm, the entirety of which is hereby incorporated herein by reference.

Battery efficient security can involve several issues. A first issue relates to crypto policy in the GPRS access network. 3GPP TR 33.863 v0.2.0 contains provisions that require the upgrade of GGSNs and SGSNs, including the upgrade of the current GPRS infrastructures.

In particular, 3GPP TR 33.863 v0.2.0 describes a pre-condition that “The SGSN/MME has indicated the supported security configuration of the GERAN/E-UTRAN to the H-PLMN i.e. the used confidentiality algorithm and integrity protection algorithm (e.g. for GERAN: GEA4 in use, e.g for LTE 128-EEA2 and 128-EIA2 in use).” Such an indication is not conventionally available on the interface between SGSN and HLR.

Moreover, when e2m security is guaranteed for the user plane then it may not be important whether the user plane is additionally encrypted over the access between UE and SGSN. Additionally, strong signaling protection between the UE and SGSN may not be needed, as the termination point of e2m security, the HSE, can control whether the desired e2m security association was established or not. This control by the HSE can preclude the man-in-the-middle attacks which are possible in 2G.

Secondly, the indication described 3GPP TR 33.863 v0.2.0 may not help the SGSN to learn which crypto algorithms have to be applied for this UE from the home network's point of view.

Furthermore, if the visited network hosting the SGSN or the MME cannot be trusted, then there is no apparent reason why the home network would trust this indication from the SGSN. Furthermore, for LTE this indication may not make sense, as strong cryptographic algorithms are in place in LTE.

A second issue relates to authentication and key usage policy in the visited network. 3GPP contribution S3-151367, which can be found at ftp://ftp.3gpp.org/TSG_SA/WG3_Security/TSGS3_79_Nanjing/Docs/, states that an HLR/HSS-driven authentication policy is needed because the H-PLMN is better informed than the V-PLMN, as to the best authentication policy which will maximize the battery capacity of the UE. Moreover, the same document states that the HLR/HSS should provide an expiration time for the authentication vectors and specifically states, “When the expiration time is reached, the SGSN/MME should either use the stored, unused and not expired AV or request new AV to the HLR/HSS.” S3-151367 is hereby incorporated herein by reference. However, there is no conventional way of communicating such a policy to the SGSN or MME.

A third issue relates to usage of e2m security. 3GPP TR 33.863 v0.2.0 describes a mechanism for establishing e2m security between UE and HSE. For this purpose, cryptographic keys are established with the support of the HLR or HSS. However, not all UEs may require e2m security. For example, only certain CIoT UEs may need e2m security.

Furthermore, S3-151367 mentions an authentication management field (AMF) to be used in deriving keys for e2m security. The AMF is a 16-bit field in an authentication vector that is generated in the Authentication Centre (AuC). However, there is no conventional way for the AuC to know whether the bit in the AMF related to e2m security for CIoT has to be set. Additionally, neither 3GPP TR 33.863 v0.2.0 nor S3-151367 indicates how the HLR or HSS could know whether keys for establishing e2m security are required for a particular subscription.

A fourth issue relates to key derivation for HSE. 3GPP TR 33.863 v0.2.0 describes a mechanism for establishing e2m security between UE and HSE. In this mechanism, keys called “E2E CK/IK” are derived in a deterministic fashion from the UMTS AKA keys or EPS AKA keys CK and IK. This approach is based on there being one e2m security termination point HSE. However, the UE may want to communicate with two or more such termination points, such as HSE1 and HSE2. Conventionally there is no mechanism that derives multiple keys “E2E CK/IK”, one for each such termination point.

### SUMMARY

According to a first embodiment, a method can include including a first field in a subscriber profile. The first field can be configured to determine a minimum strength for at least one cryptographic algorithm to be used between a user equipment associated with this subscription and a serving node. The method can also include transmitting the subscriber profile between a subscriber database and the support node.

In a variant, the support node can be a serving general packet radio service support node.

In a variant, the subscriber database can be a home location register.

In a variant, the transmitting can include transmitting the subscriber profile from the subscriber database to the support node or transmitting the subscriber profile from the support node to the subscriber database.

In a variant, the subscriber profile can include at least one of a general packet radio service subscriber profile, a third generation subscriber profile, or a fourth generation subscriber profile.

In a variant, the first field can include a list of permitted algorithms or a list of forbidden algorithms.

In a variant, the method can further include including a second field in the subscriber profile. The second field can be configured to determine an authentication policy required for a subscriber corresponding to the subscriber profile.

In a variant, the method can further include including, in the second field, a minimum and maximum allowed numbers of authentication in a certain period.

In a variant, the second field can further be configured to indicate whether derivation of new keys K_{eNB} from an existing K_{ASME} is permitted.

In a variant, the method can further include including a third field in the subscriber profile. The third field can be configured to indicate to a network element whether the network element needs to provide support for establishing end-to-middle security.

In a variant, the network element can be a home location register or a home subscriber server.

In a variant, the method can also include including, in the third field names, identities, addresses, or any combination thereof, of at least one home public land mobile network security endpoint authorized to communicate with the user equipment.

According to a second embodiment, an apparatus can include means for performing the method according to the first embodiment in any of its variants.

According to a third embodiment, an apparatus can include at least one processor and at least one memory and computer program code. The at least one memory and the computer program code can be configured to, with the at least one processor, cause the apparatus at least to perform the method according to the first embodiment in any of its variants.

According to a fourth embodiment, a computer program product may encode instructions for performing a process including the method according to the first embodiment in any of its variants.

According to a fifth embodiment, a non-transitory computer readable medium may encode instructions that, when executed in hardware, perform a process including the method according to the first embodiment in any of its variants.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a system according to certain embodiments.

### DETAILED DESCRIPTION

Battery efficient security can involve several issues, as outlined above. Some of these issues may be related in that certain embodiments may address them through extensions to the subscriber profile for CIoT purposes. Another issue relates to deriving different keys for different servers, but may be resolved in combination with or separately from the other issues.

Certain embodiments may address the issue of crypto policy in a GPRS access network. For example, certain embodiments may include a field in the GPRS subscriber profile. This field can determine the minimum strength(s) for the cryptographic algorithm(s) to be used between the UE with this subscription and the SGSN. For 3G and 4G subscriptions, this field may not be needed. The field can determine a general minimum strength for all cryptographic algorithms, or respective minimum strengths for each corresponding cryptographic algorithm. Other ways of indicating minimum strength, such as by groups, are also permitted.

Certain embodiments may allow the home network to flexibly inform the serving node in the visited network of the required crypto policy for the radio access.

The field in the subscriber profile may, for example, contain lists of permitted algorithms or lists of forbidden algorithms. These can respectively referred to as white lists and black lists. These lists can be encoded in the form of an efficient encoding, using either the algorithm codes from the radio access networks, or different codes. The different codes may be specific to this use in the subscriber profile.

Certain embodiments, therefore, may be able to provide e2m security without having to upgrade the interface between the SGSN and the HLR, as subscriber profiles may be supportable without additional upgrades. Furthermore, an SGSN not recognizing the field can ignore the field. Thus, certain embodiments may provide for backwards compatibility.

Additionally, certain embodiments may address the issue of authentication and key usage policy in the visited network. For example, certain embodiments may include another field in the GPRS, 3G, or 4G subscriber profiles. The additional field can determine the authentication policy required for the subscriber.

Certain embodiments can address the issue of authentication and key usage policy as an add-on to addressing the issue of crypto policy in a GPRS access network. Thus, both issues may be addressed by extending a subscriber profile for CIoT purposes

The field in the subscriber profile could state the minimum and maximum allowed numbers of authentication in a certain period. The minimum is relevant for security, the maximum is relevant for battery-saving as authentications can drain the battery of very low cost CIoT devices.

In addition, for LTE, the field can give an indication whether the HSE is allowed to derive new keys K_{eNB} from an existing K_{ASME}, as described in 3GPP TS 33.401, clause 7.2.9.2.

Certain embodiments can further address the issue of usage of e2m security. In certain embodiments, yet another field can be included in the GPRS, 3G, or 4G subscriber profiles. The field can indicate to the HLR or HSS whether the HLR or HSS needs to provide support for establishing e2m security. This field can be used as an add-on to one or both of the previously described fields.

The field in the GPRS, 3G or 4G subscriber profiles could contain just one bit. This bit could be sent from the HLR or HSS front ends to the AuC to indicate whether to set a particular bit in the Authentication Management Field (AMF). This field does not need to be sent to the serving node and can be kept internal to the HLR or HSS. In certain embodiments, this field could be managed by management entity for CIoT subscribers.

The field could contain the names, or identities, or addresses, of the HSE or HSEs authorized to communicate with the UE. Any combination of names, identities, and/or addresses can be provided in the field.

Certain embodiments may address the issue of key derivation for HSE. For example, there may be two termination points, HSE1 and HSE2, for e2m security. HSE1 and HSE2 may be running two different IoT applications. There may be separate application level security to separate applications. Alternatively, HSE1 and HSE2 may not reside in the home network, but may be hosted by third parties. Thus, for this additional or alternative reason it may be useful for HSE1 and HSE2 to have separate security with different cryptographic keys. Otherwise, a compromise of one HSE1 may also compromise the second one, and HSE1 could spy on HSE2.

New keys E2E-HSE can be used instead of the keys “E2E CK/IK” described in TR 33.863 v0.2.0. The purpose of the key derivation, such as e2m security for CIoT, can be input to the key derivation together with the name or identity or address of the HSE. In this or any other way, it can be arranged that HSE1 cannot know the key of HSE2, and vice versa.

In order to derive the new keys E2E-HSE, any Key Derivation Function (KDF) can be used. For example, the KDF defined in 3GPP TS 33.220, Annex B, and used in 3GPP TS 33.401, Annex A, could be used. The name of the HSE, as well as the keys CK and IK resulting from a run of UMTS AKA or EPS AKA when authenticating the UE, can be provided as input to the key derivation.

So, an example of a formula for obtaining the desired keys can be as follows: E2E-HSE=KDF (CK, IK; HSE-id, e2m-CIoT). where KDF is the Key Derivation Function from TS 33.220, the input key is equal to the concatenation CK∥IK of CK and IK, HSE-id is the name of the HSE, and “e2m-CIoT” indicates that the key is for use with e2m-security in CIoT.

In accordance with certain embodiments, more than one HSE can be used by one UE simultaneously without the risk of lowering security. For example, security may be preserved even when both HSEs are not within a home network.

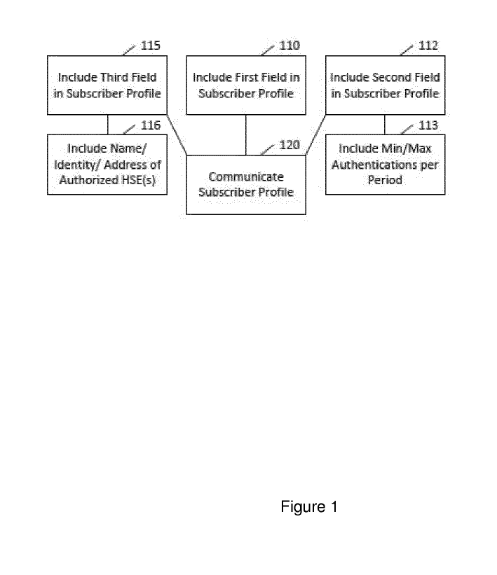

FIG. 1 illustrates a method according to certain embodiments. As shown in FIG. 1, a method can include, at 110, including a first field in a subscriber profile. The first field can be configured to determine a minimum strength for at least one cryptographic algorithm to be used between a user equipment associated with this subscription and a support node. The method can also include, at 120, transmitting the subscriber profile between a subscriber database and the support node. The subscriber profile may be communicated between other networks in addition to, or instead of, the subscriber database and the support node.

The support node can, for example, be a serving general packet radio service support node. The subscriber database can be a home location register or other database.

The transmitting at 120 can include transmitting the subscriber profile from the subscriber database to the support node or transmitting the subscriber profile from the support node to the subscriber database. This transmission may be directly between the support node and the subscriber database or via one or more other nodes.

The subscriber profile can be a general packet radio service subscriber profile, a third generation subscriber profile, a fourth generation subscriber profile, or any combination thereof. Other kinds of subscriber profiles are also permitted.

The first field can include a list of permitted algorithms, a list of forbidden algorithms, or both kinds of lists.

The method can further include, at 112, including a second field in the subscriber profile. The second field can be configured to determine an authentication policy required for a subscriber corresponding to the subscriber profile.

The method can additionally include, at 113, including, in the second field, a minimum and maximum allowed numbers of authentication in a certain period. Other aspects of an authentication policy can likewise be indicated in the second field. For example, the second field can further be configured to indicate whether derivation of new keys K_{eNB} from an existing K_{ASME} is permitted.

The method can also include, at 115, including a third field in the subscriber profile. The third field can be configured to indicate to a network element whether the network element needs to provide support for establishing end-to-middle security. The network element can be a home location register or a home subscriber server.

The method can further include, at 116, including, in the third field names, identities, addresses, or any combination thereof, of at least one home public land mobile network security endpoint authorized to communicate with the user equipment.

Although the fields are designated as first, second, and third fields, for convenient and clear reference, the fields may be present in the subscriber database in any order with respect to each other and with respect to other fields in the database. Thus, the first field does not have to be the first field of the entire subscriber database, nor present first in time, nor even in a first position relative to the other fields, if the other fields are present. In certain embodiments, two or more of the fields may be concatenated together, and may still be considered first, second, and third fields. Thus, while individual and distinct fields are one option, such an option is not required in all embodiments.

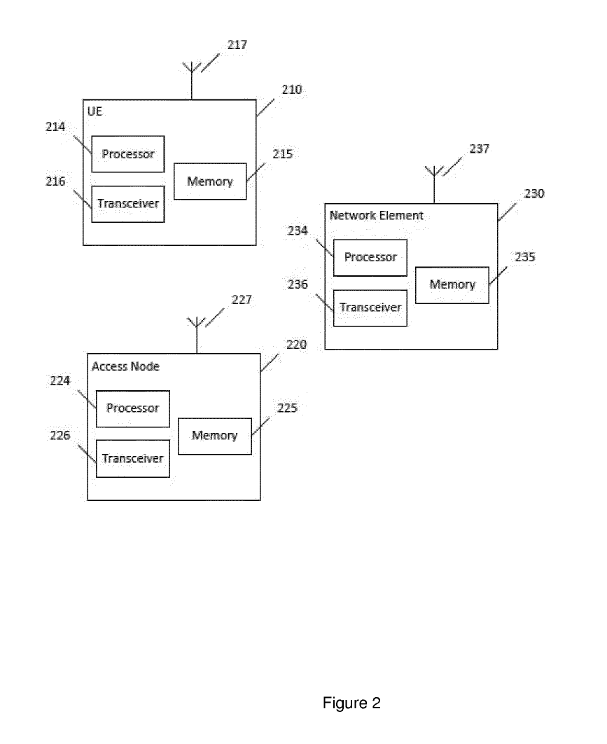

FIG. 2 illustrates a system according to certain embodiments of the invention. In one embodiment, a system may include multiple devices, such as, for example, at least one UE 210, at least one access node 220, which may be an SGSN or MME, or other network element terminating access security, and at least one network element 230, which may be an HSE, HLR, or any of the other core network elements, either in a home network or a visited network, described herein.

Each of these devices may include at least one processor, respectively indicated as 214, 224, and 234. At least one memory can be provided in each device, and indicated as 215, 225, and 235, respectively. The memory may include computer program instructions or computer code contained therein. The processors 214, 224, and 234 and memories 215, 225, and 235, or a subset thereof, can be configured to provide means corresponding to the various blocks of FIG. 1.

As shown in FIG. 2, transceivers 216, 226, and 236 can be provided, and each device may also include an antenna, respectively illustrated as 217, 227, and 237. Other configurations of these devices, for example, may be provided. For example, network element 230 may be configured for wired communication, instead of or in addition to wireless communication, and in such a case antenna 237 can illustrate any form of communication hardware, without requiring a conventional antenna.

Transceivers 216, 226, and 236 can each, independently, be a transmitter, a receiver, or both a transmitter and a receiver, or a unit or device that is configured both for transmission and reception.

Processors 214, 224, and 234 can be embodied by any computational or data processing device, such as a central processing unit (CPU), application specific integrated circuit (ASIC), or comparable device. The processors can be implemented as a single controller, or a plurality of controllers or processors.

Memories 215, 225, and 235 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 210, access node 220, and network element 230, to perform any of the processes described herein (see, for example, FIG. 1). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 2 illustrates a system including a UE, access node, and network element, embodiments of the invention may be applicable to other configurations, and configurations involving additional elements. For example, not shown, additional UEs and access network elements may be present, and additional core network elements may be present, as mentioned and discussed above.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### LIST OF ABBREVIATIONS

AuC=Authentication Centre

CIoT=Cellular Internet of Things

E2E=end-to-end

e2m=end-to-middle

HLR=Home Location Register

HSE=HPLMN Security Endpoint

HSS=Home Subscriber Server

KDF=Key Derivation Function

MME=Mobility Management entity

SGSN=Serving GPRS Support Node

1. A method, comprising:
including a first field in a subscriber profile, wherein the first field is configured to determine a minimum strength for at least one cryptographic algorithm to be used between a user equipment associated with the subscriber profile and a serving node; and
transmitting the subscriber profile between a subscriber database and the support node.

2. The method of claim 1, wherein the support node is a serving general packet radio service support node.

3. The method of claim 1, wherein the subscriber database comprises a home location register.

4. The method of claim 1, wherein the transmitting comprises transmitting the subscriber profile from the subscriber database to the support node or transmitting the subscriber profile from the support node to the subscriber database.

5. The method of claim 1, wherein the subscriber profile comprises at least one of a general packet radio service subscriber profile, a third generation subscriber profile, or a fourth generation subscriber profile.

6. The method of claim 1, wherein the first field comprises a list of permitted algorithms or a list of forbidden algorithms.

7. The method of claim 1, further comprising:
including a second field in the subscriber profile, wherein the second field is configured to determine an authentication policy required for a subscriber corresponding to the subscriber profile.

8. The method of claim 7, further comprising:
including, in the second field, a minimum and maximum allowed numbers of authentication in a certain period.

9. The method of claim 7, wherein the second field is further configured to indicate whether derivation of new keys K_{eNB} from an existing K_{ASME} is permitted.

10. The method of claim 1, further comprising:
including a third field in the subscriber profile, wherein the third field is configured to indicate to a network element whether the network element needs to provide support for establishing end-to-middle security.

11. The method of claim 10, wherein the network element comprises a home location register or a home subscriber server.

12. The method of claim 10, further comprising:
including, in the third field, names, identities, addresses, or any combination thereof, of at least one home public land mobile network security endpoint authorized to communicate with the user equipment.

13. An apparatus, comprising:
means for performing the method according to claim 1.

14. An apparatus, comprising:
at least one processor; and
at least one memory including computer program code,
wherein the at least one memory and the computer program code are configured to, with the at least one processor, cause the apparatus at least to perform
including a first field in a subscriber profile, wherein the first field is configured to determine a minimum strength for at least one cryptographic algorithm to be used between a user equipment associated with the subscriber profile and a serving node; and
transmitting the subscriber profile between a subscriber database and the support node.

15. A computer program product embodied on a non-transitory computer-readable medium, said computer readable medium encoding instructions that, when executed in hardware, perform a process comprising:
including a first field in a subscriber profile, wherein the first field is configured to determine a minimum strength for at least one cryptographic algorithm to be used between a user equipment associated with the subscriber profile and a serving node; and
transmitting the subscriber profile between a subscriber database and the support node.

16. (canceled)

17. An apparatus according to claim 14, wherein the transmitting comprises transmitting the subscriber profile from the subscriber database to the support node or transmitting the subscriber profile from the support node to the subscriber database.

18. The apparatus of claim 14, wherein the at least one memory and computer program code are further configured to include a second field in the subscriber profile, wherein the second field is configured to determine an authentication policy required for a subscriber corresponding to the subscriber profile.

19. The apparatus of claim 18, wherein the at least one memory and computer program code are further configured to cause the apparatus to include, in the second field, a minimum and maximum allowed numbers of authentication in a certain period.

20. The apparatus according to claim 14, wherein the at least one memory and the computer program code are configured to cause the apparatus to include a third field in the subscriber profile, wherein the third field is configured to indicate to a network element whether the network element needs to provide support for establishing end-to-middle security.

21. The apparatus according to claim 20, wherein the at least one memory and the computer program code are further configured to cause the apparatus to include, in the third field, names, identities, addresses, or any combination thereof, of at least one home public land mobile network security endpoint authorized to communicate with the user equipment.
